(19) United States
(12) Patent Application Publication
(10) Pub. No.: US 2006/0265452 A1
(43) Pub. Date: Nov. 23, 2006

(54) Image management system and imaging apparatus

(75) Inventor: Hajime Shirasaka, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/435,837

(22) Filed: May 18, 2006

(30) Foreign Application Priority Data
May 18, 2005 (JP) 145105/2005

(51) Int. Cl. G06F 15/16

(52) U.S. Cl. 709/204

(57) ABSTRACT

A subject included in an image is identified accurately, and the image is stored along with the identification data identifying the subject associated with the image. When a subject is imaged by an imaging means, face data of the subject are extracted from the image by a face extracting means. Identification data and face data are received by a receiving means from a wireless tag held by the subject, and the extracted face data are checked with the received face data by a subject identifying means to obtain the identification data associated with the received face data that match with the extracted face data. Thus, the subject included in the image is identified. The image is stored in an image storing means, which is a hard disk or a semiconductor memory, along with the identification data obtained by the subject identifying means associated with the image.

### BACKGROUND OF THE INVENTION

1. Field of the Invention

The present invention relates to an image management system and imaging apparatus in which a subject having a wireless tag is imaged, and the image is managed using identification data unique to the subject obtained by identifying the subject included in the image.

2. Description of the Related Art

It is known that Radio frequency identification (RFID) tags are used to identify imaged subjects, and the image is stored along with the subject identification data associated therewith as described, for example, in Japanese Unexamined Patent Publication No. 2004-080347. According to the patent publication described above, when a subject having a wireless tag is imaged, the tag number transmitted from the tag, the time of receipt of the tag number, and the time of imaging the subject are recorded along with the image. Then, the subject included in the image is identified by checking the time of receipt of the tag number with the time of imaging. An electromagnetic wave or an ultrasonic wave is irradiated on the tag such that the irradiation angle of the electromagnetic wave or ultrasonic wave corresponds to the angle of view of the camera when receiving the tag number from the wireless tag.

The method disclosed in the patent publication described above, however, has a disadvantage that it is unable to accurately locate the subject in the image, since there is a certain limitation to narrow down the irradiation area of the electromagnetic wave or ultrasonic wave when receiving the tag number from the wireless tag. More specifically, when a plurality of subjects located in proximity with each other is included in an image as, for example, in a group photograph, tag numbers of a plurality of subjects are received simultaneously if an electromagnetic wave or the like is irradiated at an irradiation angle associated with the angle of view of the camera. In particular, when a plurality of subjects is viewed overlapped back and forth with each other from the direction of the camera, the distinction between the locations of the subjects is impossible to be made by changing the direction of the electromagnetic wave to be irradiated. As described above, the method disclosed in Japanese Unexamined Patent Publication No. 2004-080347 has a disadvantage that it is difficult to obtain the arrangement data of the subjects when a plurality of subjects is present in an image.

It is, therefore, an object of the present invention to provide an image management system and imaging apparatus capable of accurately identifying a subject included in an image, and storing the image along with the identification data associated therewith.

### SUMMARY OF THE INVENTION

An image management system of the present invention comprises:

a wireless tag having stored therein face data of a subject and identification data for identifying the subject;

a receiving means for receiving the identification data and the face data from the wireless tag;

an imaging means for imaging the subject;

a face extracting means for extracting face data of the subject from the image obtained by the imaging means;

a subject identifying means for checking the face data extracted by the face extracting means with the face data received from the wireless tag to obtain the identification data associated with the face data received from the wireless tag that match with the extracted face data as the identification data of the subject included in the image; and

an image storing means for storing the image along with the identification data of the subject obtained by the subject identifying means associated therewith.

An imaging apparatus of the present invention comprises:

a receiving means for receiving face data of a subject and identification data for identifying the subject from a wireless tag having stored therein the face data and the identification data;

an imaging means for imaging the subject;

a face extracting means for extracting face data of the subject from the image obtained by the imaging means;

a subject identifying means for checking the face data extracted by the face extracting means with the face data received from the wireless tag to obtain the identification data associated with the face data received from the wireless tag that match with the extracted face data as the identification data of the subject included in the image; and

an image storing means for storing the image along with the identification data of the subject obtained by the subject identifying means associated therewith.

Here, the face data may be any data as long as they represent facial characteristics of the subject. The data may be, for example, characteristic amounts of a facial complexion, respective distances between the eyes, nose, and mouth, facial profile, or the like.

The identification data may be any data as long as they are unique to a subject and allow the subject to be identified, such as the identification data, name of the subject, or the like.

The image storing means may be any means as long as it is capable of storing the image along with the identification data associated therewith. The identification data may be stored in the header of the image.

When a plurality of face data is included in the image, and the identification data and face data are received by the receiving means from a plurality of wireless tags, a configuration may be adopted in which the face extracting means extracts the plurality of face data from the image. Here, the subject identifying means checks the plurality of face data extracted by the face extracting means with the face data received from the plurality of wireless tags to obtain the identification data associated with the face data received from each of the plurality of wireless tags that match with each of the extracted face data as the identification data of each of the subjects included in the image, and to obtain the locations of the plurality of face data within the image as arrangement data of the plurality of identification data. Further, the image storing means stores the image along with the identification data of the plurality of subjects and the arrangement data obtained by the subject identifying means associated therewith.

Here, the arrangement data may be any data as long as they are capable of identifying how a plurality of subjects is arranged within an image. For example, the arrangement data may be coordinate data indicating respective locations of the face data of the plurality of subjects within the image, or the data indicating the arrangement order of the plurality of subjects.

Another image management system of the present invention comprises:

a wireless tag having stored therein identification data for identifying a subject;

a receiving means for receiving the identification data from the wireless tag;

an imaging means for imaging the subject;

a face extracting means for extracting face data of the subject from the image obtained by the imaging means;

a face data storing means having stored therein identification data of the subject along with face data of the subject associated therewith;

a subject identifying means for checking the face data extracted by the face extracting means with the face data stored in the face data storing means to obtain the identification data associated with the face data stored in the face data storing means that match with the extracted face data as the identification data of the subject included in the image; and

an image storing means for storing the image along with the identification data of the subject obtained by the subject identifying means associated therewith.

Another imaging apparatus of the present invention comprises:

an imaging means for imaging a subject;

a face extracting means for extracting face data of the subject from the image obtained by the imaging means;

a receiving means for receiving identification data for identifying the subject from a wireless tag having stored therein the identification data;

a face data storing means having stored therein identification data of the subject along with face data of the subject associated therewith;

a subject identifying means for checking the face data extracted by the face extracting means with the face data stored in the face data storing means to obtain identification data associated with the face data stored in the face data storing means that match with the extracted face data as the identification data of the subject included in the image; and

an image storing means for storing the image along with the identification data of the subject obtained by the subject identifying means associated therewith.

Here, the face data may be any data as long as they represent facial characteristics of the subject. The data may be, for example, characteristic amounts of a facial complexion, respective distances between the eyes, nose, and mouth, facial profile, or the like.

The identification data may be any data as long as they are unique to a subject and allow the subject to be identified, such as the identification data, name of the subject, or the like.

The image storing means may be any means as long as it is capable of storing the image along with the identification data associated therewith. The identification data may be stored in the header of the image.

When a plurality of face data is included in the image, and the identification data are received by the receiving means from a plurality of wireless tags, a configuration may be adopted in which the face extracting means extracts the plurality of face data from the image. Here, the subject identifying means checks the plurality of face data extracted by the face extracting means with the face data stored in the face data storing means to obtain the identification data associated with the face data stored in the face data storing means that match with each of the extracted face data as the identification data of each of the subjects included in the image, and to obtain the locations of the plurality of face data within the image as arrangement data of the plurality of identification data. Further, the image storing means stores the image along with the identification data of the plurality of subjects and the arrangement data obtained by the subject identifying means associated therewith.

Here, the arrangement data may be any data as long as they are capable of identifying the locations of the subjects included in an image. For example, the arrangement data may be coordinate data indicating respective locations of the face data of the plurality of subjects within the image, or the data indicating the arrangement order of the plurality of subjects.

The image management system and imaging apparatus according to the first embodiment of the present invention includes a wireless tag having stored therein face data of a subject and identification data for identifying the subject; a receiving means for receiving the identification data and the face data from the wireless tag; an imaging means for imaging the subject; a face extracting means for extracting face data of the subject from the image of the subject received by the imaging means; a subject identifying means for checking the face data extracted by the face extracting means with the face data received from the wireless tag to identify the subject included in the image; and an image storing means for storing the image along with the identification data of the subject obtained by the subject identifying means associated therewith. Thus, the subject included in the image obtained by the imaging may be identified through matching of the face data, so that the subject included in the image obtained by the imaging may be identified accurately.

Further, when a plurality of face data is included in the image, and the identification data and face data are received by the receiving means from a plurality of wireless tags, if a configuration is adopted in which the face extracting means extracts the plurality of face data from the image, the subject identifying means checks the plurality of face data extracted by the face extracting means with the face data received from the plurality of wireless tags to obtain the identification data associated with the face data received from each of the plurality of wireless tags that match with each of the extracted face data as the identification data of each of the subjects included in the image, and to obtain the locations of the plurality of face data within the image as arrangement data of the plurality of identification data, and the image storing means stores the image along with the plurality of identification data and the arrangement data associated therewith, the arrangement data of the subjects may be identified accurately based on the face data even when accurate identification of the subjects is difficult by the identification method which bases on the locations of the wireless tags received, such as the case when taking a group photograph in which a plurality of subjects is arranged in overlapping manner. Further, when receiving identification data from the wireless tags, no timewise change is required in the direction of the electromagnetic wave or the like to be irradiated to identify the locations of the wireless tags, so that the time required for identifying the subjects before or after the imaging may be reduced.

The image management system and imaging apparatus according to the second embodiment of the present invention includes a wireless tag having stored therein identification data for identifying a subject; a receiving means for receiving the identification data from the wireless tag; an imaging means for imaging the subject; a face extracting means for extracting face data of the subject from the image obtained by the imaging means; a face data storing means having stored therein identification data of the subject along with face data of the subject associated therewith; a subject identifying means for checking the face data extracted by the face extracting means with the face data stored in the face data storing means to obtain the identification data associated with the face data stored in the face data storing means that match with the extracted face data as the identification data of the subject included in the image; and an image storing means for storing the image along with the identification data of the subject obtained by the subject identifying means associated therewith. Thus, the subject included in the image obtained by the imaging may be identified through matching of the face data, so that the subject included in the image obtained by the imaging may be identified accurately.

Further, when a plurality of face data is included in the image, and the identification data are received by the receiving means from a plurality of wireless tags, if a configuration is adopted in which the face extracting means extracts the plurality of face data from the image, the subject identifying means checks the plurality of face data extracted by the face extracting means with the face data stored in the face data storing means to obtain the identification data associated with the face data stored in the face data storing means that match with each of the extracted face data as the identification data of each of the subjects included in the image, and to obtain the locations of the plurality of face data within the image as arrangement data of the plurality of identification data, and the image storing means stores the image along with the plurality of identification data and the arrangement data associated therewith, the arrangement data of the subjects may be identified accurately based on the face data even when accurate identification of the subjects is difficult by the identification method which bases on the locations of the wireless tags received, such as the case when taking a group photograph in which a plurality of subjects is arranged in overlapping manner. Further, when receiving identification data from the wireless tags, no timewise change is required in the direction of the electromagnetic wave or the like to be irradiated to identify the locations of the wireless tags, so that the time required for identifying the subjects before or after the imaging may be reduced.

### BRIEF DESCRIPTION OF THE DRAWINGS

FIG. 1 is a block diagram of the image management system according to an embodiment of the present invention.

FIG. 2 is a flow diagram illustrating an exemplary operation of the image management system of the present invention.

FIG. 3 is a block diagram of the image management system according to another embodiment of the present invention.

FIG. 4 is a block diagram illustrating sections around the subject identifying means in the image management system shown in FIG. 3.

### DESCRIPTION OF THE PREFERRED EMBODIMENTS

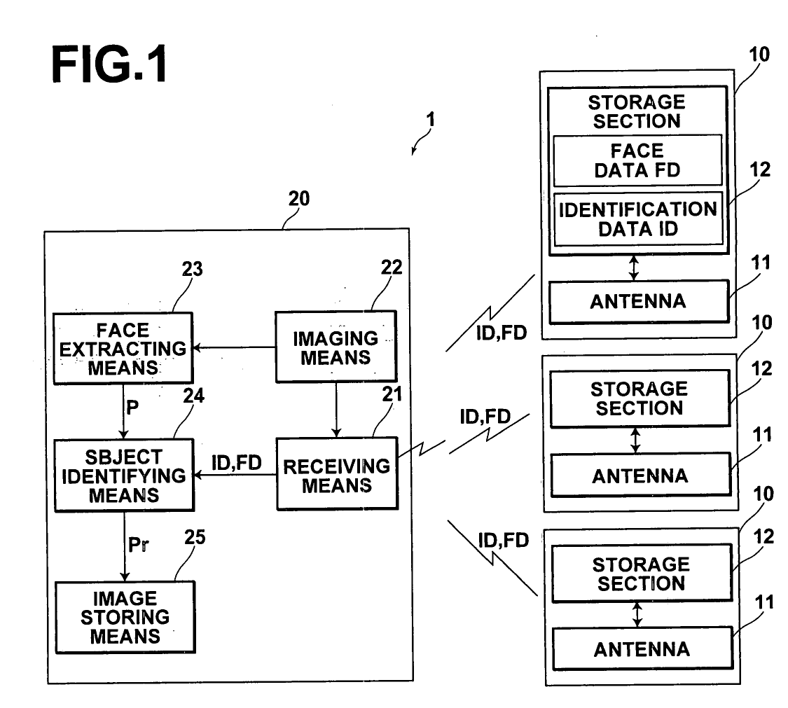

Hereinafter, embodiments of the image management system and imaging apparatus of the present invention will be described in detail with reference to accompanying drawings. FIG. 1 is a block diagram of an image management system and imaging apparatus according to a preferred embodiment. The image management system 1 shown in FIG. 1 stores an image P obtained by imaging a subject S having a wireless tag 10 along with identification data ID associated therewith. In FIG. 1, the management system comprises an imaging apparatus 20 having image management capabilities, and the wireless tag 10 held by the subject S.

Here, the wireless tag 10 is, for example, a contactless IC tag (RFID tag) held by the subject S to be imaged by the imaging means 22. The wireless tag 10 includes an antenna 11 and a memory 12, and data stored in the memory 12 is transmitted from the antenna 11 to a receiving means 21, or data transmitted from the receiving means 21 is received by the antenna 11.

The memory 12 has stored therein identification data ID which is unique to the subject S for identifying the subject and face data FD of the subject S, both of which are transmitted to the receiving means 21. Here, the face data FD include face-related data used in the known face extraction or face authentication techniques, such as characteristic amounts of a facial complexion, respective distances between the eyes, nose, and mouth, or facial profile, while the identification data includes, for example, name or an identification code of the subject S.

Hereinafter, imaging apparatus 20 will be described with reference to FIG. 1. The imaging apparatus 20 includes a receiving means 21 for receiving the identification data ID and face data FD from the wireless tag 10, an imaging means 22 for imaging the subject S, and a face extracting means 23 for extracting face data of the subject S from the image P of the subject S obtained by the imaging means 22. The apparatus further includes a subject identifying means 24 for checking the face data FD extracted by the face extracting means 23 with the face data FD received from the wireless tag to obtain the identification data ID associated with the face data FD received from the wireless tag 10 that match with the extracted face data FD as the identification data ID of the subject S included in the image P, and an image storing means for storing the image P along with the identification data ID of the subject S obtained by the subject identifying means 24 associated therewith.

Here, the receiving means 21 receives face data FD and identification data ID from the wireless tag 10 by irradiating, for example, an electromagnetic wave or the like. It may also have transmission capabilities for transmitting predetermined data to the wireless tag 10.

If face data FD is stored in encrypted form in the wireless tags 10, the receiving means 21 may include a function for decrypting the face data FD. More specifically, the receiving means 21 may include a pass word stored therein for decrypting data from a particular wireless tag 10 in order to decode the face data FD received from the particular wireless tag 10. This may prevent the face data FD to be received by anyone else's receiving means 21 and misused, so that the security may be enhanced.

The imaging means 22 is capable of both imaging a subject and processing the image obtained by the imaging. For example, when the subject S is imaged, the image P is outputted as image data in JPEG format or the like.

The face extracting means 23 extracts the face data FD of the subject S from the image P obtained by the imaging means 22. Here, as for the technique used for extracting face data FD in the face extracting means 23, for example, a method in which the approximate location and size of the face in the image P are detected to extract the face data FD from the region of the image P indicated by the location and size, or other known techniques may be used. If a plurality of face data FD is present in the image P, all of the face data FD included in the image P are extracted by the face extracting means 23.

The subject identifying means 24 checks the face data FD included in the image P with the face data FD received by the receiving means 21 to extract the identification data ID corresponding to the face data FD included in the image P, thereby identifying the subject S included in the image P. The image storing means 25 stores the image P obtained by the imaging means 22 along with the identification data ID of the subject obtained by the subject identifying means 24 associated therewith, which is, for example, stored as header data of the image P.

The technique for identifying the subject S through matching of the face data FD included in the image P as described above allows the imaged subject to be identified accurately in a short time. That is, if the subject S is identified based on the time of receipt of the data from the wireless tag 10 or the like, the receiving timing and shutter timing of the imaging means 22 are not always occur at the same time, so that the identification accuracy of the subject S is degraded. On the other hand, the identification accuracy of the subject S may be improved by identifying the subject S based on the identification of the face data FD included in the image P as described above.

Further, the image P is stored along with the identification data ID associated therewith, so that the management of the image P such as sorting a plurality of images P by each of the imaged subjects S or making extra prints may be facilitated.

Here, if a single face data FD is present in the image P, and the face data FD and identification data ID are received by the receiving means 21 from a plurality of wireless tags 10, the face data FD are extracted by the face extracting means 23, and the extracted face data FD are checked by the subject identifying means 24 with the plurality of face data FD received from the wireless tags 10. Then, the identification data ID associated with the matched face data FD are obtained by the subject identifying means 24, and the image P is stored in the image storing means 25 along with the identification data ID associated therewith.

Further, if a plurality of face data FD is present in the image P, and face data FD and identification data ID are received by the receiving means 21 from a single wireless tag 10, all of the face data FD included in the image P are extracted by the face extracting means 23, and the extracted face data FD are checked with the face data received from the wireless tag 10 by the subject identifying means 24. Then the identification data ID corresponding to the matched face data FD are obtained by the subject identifying means 24, and the image P is stored in the image storing means 25 along with the identification data ID associated therewith.

Still further, if a plurality of face data FD is present in the image P, and the face data FD and identification data ID are received by the receiving means 21 from a plurality of wireless tags 10, all of the face data FD included in the image P are extracted by the face extracting means 23, and the extracted face data FD are checked with the face data received from each of the wireless tags 10 by the subject identifying means 24. Then, the identification data ID corresponding to each of the matched face data FD are obtained by the subject identifying means 24, and the image P is stored in the image storing means 25 along with the identification data ID associated therewith.

Further, the subject identifying means 24 has capabilities to obtain arrangement data of a plurality of subject S as well as to identify a plurality of subject S. More specifically, the subject identifying means 24 checks a plurality of face data, and if a plurality of identification data ID is obtained through matching, it also identifies positional relationship among the plurality of face data FD within the image P. Here, the subject identifying means 24 obtains, for example, coordinate data indicating respective locations of the face data FD of the plurality of subjects S within the image P, or the data indicating the arrangement order of the plurality of subjects S as the arrangement data. Then, the image P is stored in the image storing means 25 along with the identification data ID and the arrangement data associated with the image P.

In this way, the arrangement data of the subjects S are obtained based on the face data, so that the arrangement data of the subjects S may be identified accurately in a short time. That is, if the locations of the subjects are identified based on the locations of the wireless tags 10 received as in the prior art, if, for example, two subjects S overlap back and forth with each other in the direction of the electromagnetic wave irradiated by the receiving means 21, it is impossible to correctly identify the respective locations of the subjects S. Further, when receiving identification data ID and the like from the wireless tags 10 before or after imaging the subjects, timewise changes are required in the direction of the electromagnetic wave to be irradiated to identify the locations of the wireless tags 10. On the other hand, if the subjects S and the locations thereof are identified using the face data FD as described above, the identification accuracy for the subjects may be improved, and the time required for the identification may be reduced.

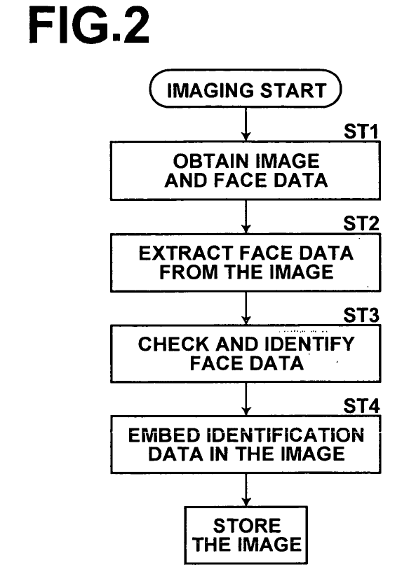

FIG. 2 is a flow diagram illustrating an exemplary operation of the image management system of the present invention. Hereinafter, the exemplary operation of the image management system will be described with reference to FIGS. 1 and 2. When a subject S is imaged by the imaging means 22, identification data ID and face data FD are transmitted from the wireless tag 10 held by the subject S to the receiving means 21 (step ST1).

Then, in the face extracting means 23, the face data FD included in the image P obtained by the imaging means 22 are extracted (step ST2). Thereafter, in the subject identifying means 24, the face data FD included in the image P are checked with the face data FD obtained from the wireless tag 10 to obtain identification data ID corresponding to the face data FD included in the image P, thereby the subject S included in the image P is identified (step ST3). If a plurality of subjects S is included in the image P, the arrangement data of the subjects S are also identified. Then, in the image storing means 25, the identification data ID and the arrangement data obtained by the subject identifying means 24 are stored by embedding them in the header of the image P (step ST4).

According to the embodiment described above, the face data FD included in the image P obtained by the imaging means 22 are extracted by the face extracting means 23. Then the extracted face data FD are checked with the face data FD obtained from the wireless tag 10 to identify the subject included in the image P. Thereafter, the image P is stored along with the identification data ID of the identified subject S associated therewith. In this way, the subject included in the image P obtained by the imaging is identified based on the matching of the face data FD, which may result in accurate identification of the subject S included in the image P obtained by the imaging means 22. Further, when receiving identification data ID from the wireless tag, no timewise change is required in the direction of the electromagnetic wave or the like to be irradiated to identify the locations of the wireless tags. Thus, the subject S may be identified in more efficient way.

Further, when a plurality of face data FD is included in the image P, and identification data ID and face data FD are received by the receiving means 21 from a plurality of wireless tags 10, if a configuration is adopted in which the face extracting means 23 extracts the plurality of face data FD, the subject identifying means 24 checks the plurality of face data extracted by the face extracting means 23 with the face data FD received from the plurality of wireless tags 10 to obtain the identification data ID of each of the subjects S included in the image P, and to obtain the locations of the plurality of face data within the image as arrangement data of the plurality of identification data, and the image storing means 25 stores the image P along with the plurality of identification data ID and the arrangement data, then even if a plurality of subjects S is arranged in overlapping manner as, for example, in a group photograph, the identification data ID and the arrangement data of the subjects S may be identified accurately based on the face data FD, unlike the case where the locations of the subjects S are identified based on the locations of the wireless tags 10 received.

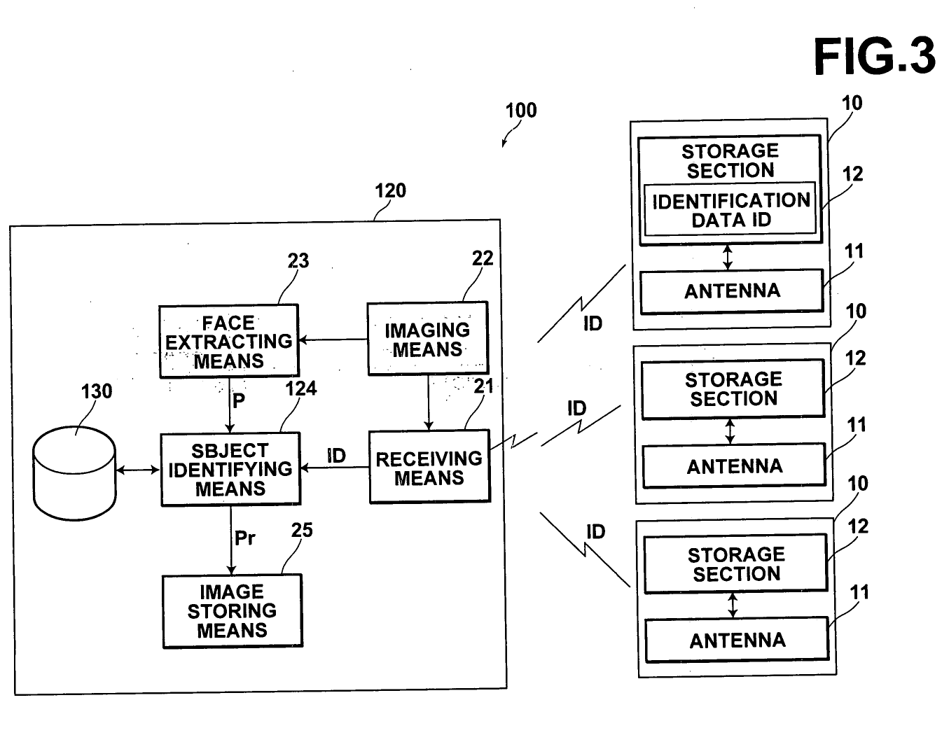

FIG. 3 is a block diagram of the image management system according to another embodiment of the present invention. Components used in the image management system 100 and imaging means 120 shown in FIG. 3 which are identical to those used in the image management system 1 and imaging means 20 shown in FIG. 1 are given the same reference numerals, and will not be elaborated upon further here.

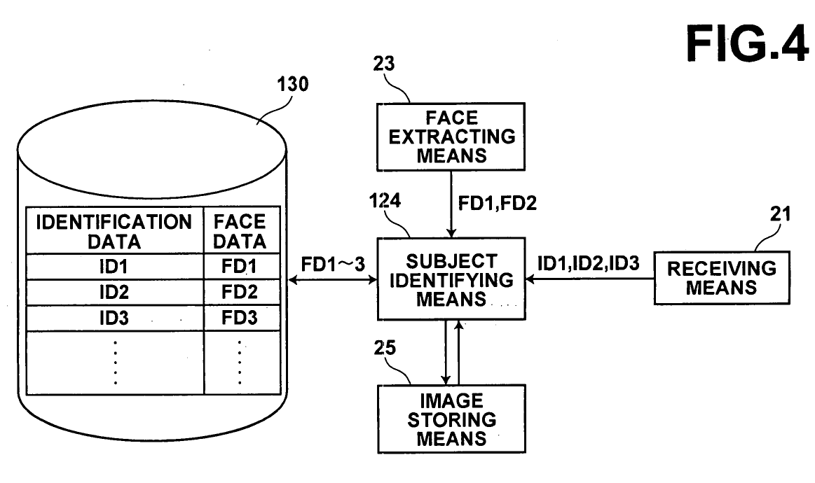

The image management system 100 shown in FIGS. 3 and 4 differs from the image management system 1 shown in FIG. 1 in that only identification data ID are stored in the wireless tag 10, and a face data storing means 130 is provided on the side of the imaging apparatus 120. The face data storing means 130 has stored therein, for example, identification data ID1 to ID3 along with face data FD1 to FD3 associated therewith, and the subject identifying means 124 checks the face data FD extracted by the face extracting means 23 with the face data stored in the face data storing means 130 to identify the subject included in the image P.

Description will be made with reference to an example case in which identification data ID1 to ID3 and face data FD1 to FD 3 for three subjects S are stored in the face data storing means 130 as shown in FIG. 4. Here, it is assumed that imaging is performed for two subjects S, but the identification data ID are received by the receiving means 21 for three subjects S.

In this case, the subject identifying means 124 extracts the face data FD1 to FD3 associated respectively with the identification data ID1 to ID3 received by the receiving means 21 from the face data storing means 130. Then, the subject identifying means 124 checks the two face data FD1 and FD2 extracted by the face extracting means 23 with the three face data FD1 to FD3 extracted from the face data storing means 130. In this way, the subject identifying means 124 identifies each of the two subjects S by extracting the identification data ID1 and ID2 corresponding respectively to the matched face data FD1 and FD2. Further, the subject identifying means 124 may also identifies the arrangement data of the face data FD1 and FD2 within the image P. In addition, the image storing means 25 stores the image P along with the identification data ID and the arrangement data associated with the image P.

In the present embodiment described above, subjects S included in the image P obtained by the imaging are identified through matching of the face data FD, so that the subjects S included in the image P may be identified accurately as in the first embodiment. Further, when receiving identification data ID from wireless tags 10, no timewise change is required in the direction of the electromagnetic wave or the like to be irradiated to identify the locations of the wireless tags 10. Thus, the subject S may be identified in more efficient way.

In particular, provision of the face data storing means 130, in which identification data ID are stored along with face data FD associated therewith, on the side of imaging apparatus 120 allows, for example, to store identification data ID and face data FD only of the subject S, who is the user of the imaging apparatus 120, and his/her friends or families. This results in no matching of face data FD takes place when identification data ID are received by the receiving means 21 from wireless tags 10 held by others, allowing more efficient subject identification and increased security.

In the image management system 100 and imaging apparatus 120 shown in FIGS. 3 and 4, as in the image management system 1 and imaging apparatus 20, when a plurality of face data FD are included in the image P, and the identification data ID are received by the receiving means 21 from a plurality of wireless tags 10, if a configuration is adopted in which the face extracting means 23 extracts the plurality of face data FD, the subject identifying means 124 checks the plurality of face data extracted by the face extracting means 23 with the face data stored in the face data storing means 130 to obtain the identification data ID of each of the subjects S included in the image P and arrangement data of the plurality of the subjects S, and the image storing means 25 stores the image P along with the plurality of identification data ID and the arrangement data, then even if a plurality of subjects S is arranged in overlapping manner as, for example, in a group photograph, the identification data and arrangement data of the subjects S may be identified accurately based on the face data FD.

Embodiments of the present invention are not limited to those described above. For example, the face extraction, subject identification, and image storage are all implemented in the imaging apparatus 20 or 120 in FIG. 1 or 3. But an embodiment in which an image management apparatus constituted by a computer or the like is provided separately from the imaging apparatus 20 or 120 may also be possible. In this case, the imaging apparatus 20 or 120 is constituted by the imaging means 22 shown in FIG. 1 or 3 as a separate imaging apparatus.

What is claimed is:

1. An image management system comprising:
a wireless tag having stored therein face data of a subject and identification data for identifying the subject;
a receiving means for receiving the identification data and the face data from the wireless tag;
an imaging means for imaging the subject;
a face extracting means for extracting face data of the subject from the image obtained by the imaging means;
a subject identifying means for checking the face data extracted by the face extracting means with the face data received from the wireless tag to obtain the identification data associated with the face data received from the wireless tag that match with the extracted face data as the identification data of the subject included in the image; and
an image storing means for storing the image along with the identification data of the subject obtained by the subject identifying means associated therewith.

2. The image management system according to claim 1, wherein when a plurality of face data is included in the image, and the identification data and the face data are received by the receiving means from a plurality of wireless tags,
the face extracting means extracts the plurality of face data from the image;
the subject identifying means checks the plurality of face data extracted by the face extracting means with the face data received from the plurality of wireless tags to obtain the identification data associated with the face data received from each of the plurality of wireless tags that match with each of the extracted face data as the identification data of each of the subjects included in the image, and to obtain the locations of the plurality of face data within the image as arrangement data of the plurality of identification data; and
the image storing means stores the image along with the identification data of the plurality of subjects and the arrangement data obtained by the subject identifying means associated therewith.

3. An imaging apparatus comprising:
a receiving means for receiving face data of a subject and identification data for identifying the subject from a wireless tag having stored therein the face data and the identification data;
an imaging means for imaging the subject;
a face extracting means for extracting face data of the subject from the image obtained by the imaging means;
a subject identifying means for checking the face data extracted by the face extracting means with the face data received from the wireless tag to obtain the identification data associated with the face data received from the wireless tag that match with the extracted face data as the identification data of the subject included in the image; and
an image storing means for storing the image along with the identification data of the subject obtained by the subject identifying means associated therewith.

4. The imaging apparatus according to claim 3, wherein when a plurality of face data is included in the image, and the identification data and the face data are received by the receiving means from a plurality of wireless tags,
the face extracting means extracts the plurality of face data from the image;
the subject identifying means checks the plurality of face data extracted by the face extracting means with the face data received from the plurality of wireless tags to obtain the identification data associated with the face data received from each of the plurality of wireless tags that match with each of the extracted face data as the identification data of each of the subjects included in the image, and to obtain the locations of the plurality of face data within the image as arrangement data of the plurality of identification data; and
the image storing means stores the image along with the identification data of the plurality of subjects and the arrangement data obtained by the subject identifying means associated therewith.

5. An image management system comprising:
a wireless tag having stored therein identification data for identifying a subject;
a receiving means for receiving the identification data from the wireless tag;
an imaging means for imaging the subject;
a face extracting means for extracting face data of the subject from the image obtained by the imaging means;
a face data storing means having stored therein identification data of the subject along with face data of the subject associated therewith;
a subject identifying means for checking the face data extracted by the face extracting means with the face data stored in the face data storing means to obtain the identification data associated with the face data stored in the face data storing means that match with the extracted face data as the identification data of the subject included in the image; and
an image storing means for storing the image along with the identification data of the subject obtained by the subject identifying means associated therewith.

6. The image management system according to claim 5, wherein when a plurality of face data is included in the image, and the identification data are received by the receiving means from a plurality of wireless tags,
the face extracting means extracts the plurality of face data from the image;
the subject identifying means checks the plurality of face data extracted by the face extracting means with the face data stored in the face data storing means to obtain the identification data associated with the face data stored in the face data storing means that match with each of the extracted face data as the identification data of each of the subjects included in the image, and to obtain the locations of the plurality of face data within the image as arrangement data of the plurality of identification data; and
the image storing means stores the image along with the identification data of the plurality of subjects and the arrangement data obtained by the subject identifying means associated therewith.

7. An imaging apparatus comprising:
an imaging means for imaging a subject;
a face extracting means for extracting face data of the subject from the image obtained by the imaging means;
a receiving means for receiving identification data for identifying the subject from a wireless tag having the identification data stored therein;
a face data storing means having stored therein identification data of the subject along with the face data of the subject associated therewith;
a subject identifying means for checking the face data extracted by the face extracting means with the face data stored in the face data storing means to obtain identification data associated with the face data stored in the face data storing means that match with the extracted face data as the identification data of the subject included in the image; and
an image storing means for storing the image along with the identification data of the subject obtained by the subject identifying means associated therewith.

8. The imaging apparatus according to claim 7, wherein when a plurality of face data is included in the image, and the identification data are received by the receiving means from a plurality of wireless tags,
the face extracting means extracts the plurality of face data from the image;
the subject identifying means checks the plurality of face data extracted by the face extracting means with the face data stored in the face data storing means to obtain the identification data associated with the face data stored in the face data storing means that match with each of the extracted face data as the identification data of each of the subjects included in the image, and to obtain the locations of the plurality of face data within the image as arrangement data of the plurality of identification data; and
the image storing means stores the image along with the identification data of the plurality of subjects and the arrangement data obtained by the subject identifying means associated therewith.
